(19) United States
(12) Patent Application Publication
(10) Pub. No.: US 2023/0124197 A1
(43) Pub. Date: Apr. 20, 2023

(54) Device and Method for Evacuating Cryptocurrency and Program Therefor

(71) Applicant: ANDGO, INC., Bunkyo-ku (JP)

(72) Inventor: Toshihide HARA, Bunkyo-ku (JP)

(21) Appl. No.: 17/434,332

(22) PCT Filed: Feb. 20, 2020
(86) PCT No.: PCT/JP2020/006779

§ 371 Date: Mar. 18, 2022

(30) Foreign Application Priority Data
Feb. 26, 2019 (JP) 2019-032392

(51) Int. Cl. G06Q 20/36; G06Q 20/38; H04L 9/06; H04L 9/00

(52) U.S. Cl. CPC G06Q 20/36; G06Q 20/3825; H04L 9/50; H04L 9/0643; H04L 2209/56

(57) ABSTRACT

The present invention enables a cryptocurrency for which the secret information needed for remittance is managed outside of an exchange to be evacuated without excessively increasing a user’s burden. A apparatus 110, in accordance with remittance instructions (S301), generates remittance transaction data T and also generates evacuation transaction data E for remitting the remainder derived by subtracting an instructed amount of remittance from the amount remittable using secret information (S302). Next, the apparatus 110 transmits the hash value of the transaction data to an apparatus 100 (S303). The apparatus 100 signs the hash value and transmits the signature to the apparatus 110 (S304). Next, the apparatus 110 generates signed remittance transaction data T′ and signed evacuation transaction data E′ (S305). The data T′ is transmitted to a blockchain network 130 (S306), and the data E′ is transmitted to a server 120 as preparation for evacuation (S307) .

### TECHNICAL FIELD

The present invention relates to an apparatus, method and program for evacuating a cryptocurrency, and more particularly, to an apparatus, method and program for evacuating a cryptocurrency for which the secret information needed for remittance is managed outside of a virtual currency exchange.

### BACKGROUND ART

With the rapid expansion of cryptocurrencies, a device called a “hardware wallet” is being used to securely store cryptocurrencies. A Hardware wallet contains a private key required for signing a transaction to remit a cryptocurrency to others. It is temporarily connected to a PC or other device with access to a blockchain network. By shutting off the wallet from the Internet except for a limited period of time during remittance, the risk of unintentional remittance of a cryptocurrency to others is suppressed.

One example of a hardware wallet is the LEDGER NANO S (registered trademark). This product is a hardware wallet that is connected to a PC via USB. A PIN code is set during the initial setup when it is first connected to the PC, and access to a private key is allowed by entering this PIN code.

Specifically, this product uses a method in which multiple secret keys can be generated hierarchically using secret information called a seed, which is 256 bits, and each secret key and the address associated with it can be reproduced from the seed. Therefore, when the power is turned on, one or more secret keys for one or more addresses used so far are reproduced from the seed, and the one or more secret keys can be utilized using the PIN code. Here, the seed is stored in a tamper-resistant, highly secure chip called the “secure element.”

Since the seed plays such a crucial role, during the initial setup, in addition to setting the PIN code, 24 recovery phrases for seed recovery are displayed and these are required to be recorded. In the event that a device is lost, using the recovery phrases, the seed can be restored to a new, compatible device, and the seed can be used to reproduce one or more private keys for one or more addresses that have been used. The seed is stored in the lost device, but the seed in the secure element is stored inaccessibly without the PIN code.

Although there are hardware wallets that take safety into consideration, all of them are used by connecting to a PC. Since there has been no hardware wallet that utilizes a smartphone that many people carry today while taking safety into consideration, the applicant has developed a hardware wallet that uses communication with a smartphone to ensure safety. In the applicant’s hardware wallet, access to the secret key managed in the wallet is made highly secure by a unique multi-factor authentication method. Also, in preparation for a situation where the user loses the device, the seed itself or information corresponding to it one-to-one is stored in a component called the recovery core for the recovery of the seed.

### Prior Art

### Non-Patent Documents

NON-PATENT DOCUMENTS 1 : webpage of AndGo, Inc. at https://www.andgo.co.jp [retrieved on 17 Feb. 2019].

### SUMMARY OF INVENTION

### Technical Problem

Seeds and the private keys generated from them are extremely important in the storage of cryptocurrencies. Although several methods have been tried, such as recording recovery phrases and using recovery cores, as mentioned above, the responsibility of managing the confidential information necessary for the remittance of cryptocurrencies, such as seeds and private keys, is entirely placed on users. There is a growing demand for secure storage of cryptocurrencies outside of virtual currency exchanges, but at the same time, the burden of having each user bear all of this responsibility on their own is significant.

The objective of the present invention is to enable the evacuation of a cryptocurrency, if necessary, for which the secret information needed for remittance is managed outside of a virtual currency exchange without excessive user burden.

The term “evacuate” as used herein means to enable remittance of a cryptocurrency in an amount corresponding to all or part of the cryptocurrency without using the secret information needed for remittance of the cryptocurrency, and “secret information” means the secret key needed to sign the transaction for remitting a cryptocurrency or the information for generating the secret key.

The expression “shut off” as used herein does not exclude temporary connection to the Internet when necessary.

### Solution to Problem

In order to achieve such an objective, a first aspect of the present invention is a method for evacuating a cryptocurrency of which secret information required for remittance is managed outside a virtual currency exchange by an apparatus, comprising: receiving an input of remittance instructions of part of the cryptocurrency from a user; obtaining remittance transaction data for remitting instructed remittance amount; obtaining evacuation transaction data for evacuating all or part of remainder after subtracting remittance amount of the remittance transaction data from entire amount of the cryptocurrency; obtaining a signature to a hash value of the remittance transaction data using the secret information; obtaining a signature to a hash value of the evacuation transaction data using the secret information; transmitting signed remittance transaction data to a blockchain network; and transmitting signed evacuation transaction data to a server storing the signed evacuation transaction data.

The second aspect of the present invention is the method of the first aspect, further including transmitting execution instructions of evacuation, which causes the signed evacuation transaction data to be transmitted to the blockchain network, to the server.

The third aspect of the present invention is the method of the first or second aspect, wherein the server is a server other than a server for providing a virtual currency exchange.

The fourth aspect of the present invention is the method of any one of the first to the third aspects, wherein, in the evacuation transaction data, a destination address which is an evacuation address is an address of which identity of the user has been verified.

The fifth aspect of the present invention is the method of the first aspect, wherein, in the evacuation transaction data, a destination address which is an evacuation address is an address provided to the user by the virtual currency exchange.

The sixth aspect of the present invention is the method according to the fifth aspect, wherein the evacuation address is specified by calling an API provided by the virtual currency exchange.

The seventh aspect of the present invention is the method according to any one of the first to the sixth aspects, wherein each step is performed by a mobile terminal, and wherein the mobile terminal receives a signature to a hash value of the signed evacuation transaction data from a device shut off from the Internet that stores the secret information.

The eighth aspect of the present invention is a method for evacuating a cryptocurrency of which secret information required for remittance is managed outside a virtual currency exchange by an apparatus, comprising: obtaining evacuation transaction data for evacuating all or part of the cryptocurrency; obtaining a signature to a hash value of the evacuation transaction data using the secret information; and transmitting signed evacuation transaction data to a server storing the signed evacuation transaction data.

A ninth aspect of the present invention is a program for causing an apparatus to perform a method for evacuating a cryptocurrency of which secret information required for remittance is managed outside a virtual currency exchange, the method comprising: obtaining evacuation transaction data for evacuating all or part of the cryptocurrency; obtaining a signature to a hash value of the evacuation transaction data using the secret information; and transmitting signed evacuation transaction data to a server storing the signed evacuation transaction data.

The tenth aspect of the present invention is an apparatus for evacuating a cryptocurrency of which secret information required for remittance is managed outside a virtual currency exchange, configured to: obtain evacuation transaction data for evacuating all or part of the cryptocurrency; obtain a signature to a hash value of the evacuation transaction data using the secret information; and transmit signed evacuation transaction data to a server storing the signed evacuation transaction data.

According to an aspect of the present invention, evacuation transaction data E is generated to evacuate all or part of the cryptocurrency, of which the secret information needed for remittance is managed outside of a virtual currency exchange. The signed evacuation transaction data E′, which is the evacuation transaction data E signed with the above secret information, is not broadcasted, but is stored on a server until the evacuation is separately instructed to be executed, and the signed evacuation transaction data E′ is broadcasted when the evacuation is instructed to be executed. In this way, the provider of this evacuation service can evacuate the cryptocurrency as necessary without accessing each user’s secret information and without placing an excessive burden of managing each user’s secret information.

### BRIEF DESCRIPTION OF DRAWINGS

FIG. 1 shows an apparatus for evacuating a cryptocurrency according to the first embodiment of the present invention.

FIG. 2 shows an example of an input screen for remittance according the first embodiment of the present invention.

FIG. 3 is a flow diagram of a method for evacuating a cryptocurrency according to the first embodiment of the invention.

FIG. 4A illustrates the procedure for performing an evacuation according to the first embodiment of the invention.

FIG. 4B illustrates the procedure for performing an evacuation according to the first embodiment of the invention.

FIG. 5 shows an example of an input screen for instructing evacuation preparation according to the second embodiment of the present invention.

### DESCRIPTION OF EMBODIMENTS

The following is a detailed description of the embodiments of the present invention with reference to the drawings.

### First Embodiment

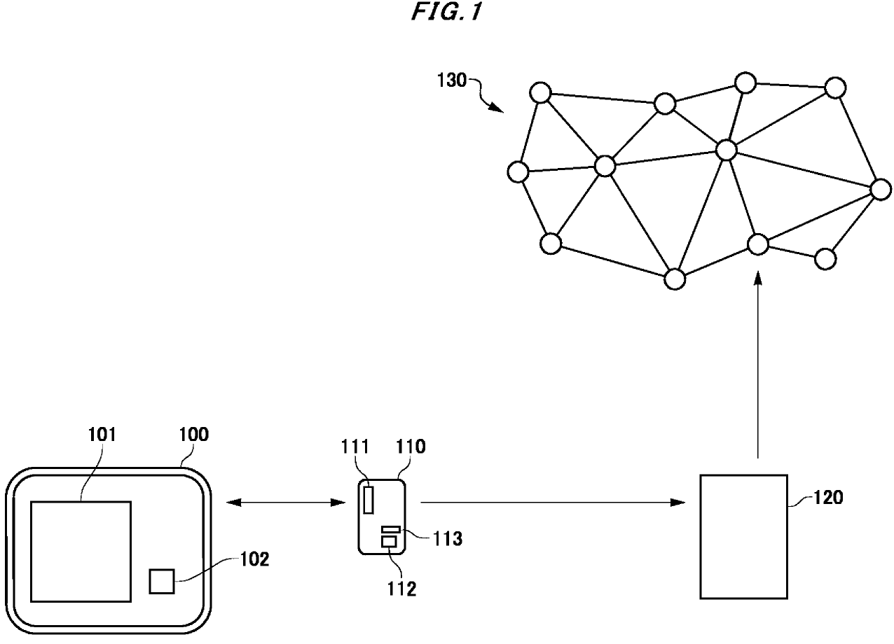

FIG. 1 shows an apparatus for evacuating a cryptocurrency according to a first embodiment of the present invention. The apparatus 110 generates transaction data T for remittance of a cryptocurrency and transmits the transaction data T or a hash value H based thereon to the device 100. The device 100 signs the hash value of the transaction data T using secret information managed by the device 100, and transmits the signature or the signed transaction data T′ with the signature added to the apparatus 110. Then, the apparatus 110 broadcasts the signed transaction data T′ to the blockchain network 130. In this case, the broadcast may be made directly from the apparatus 110 or via the server 120 with which the application for remitting a cryptocurrency installed on the device 100 communicates.

The device 100 enables access to the secret information stored therein in response to a request from an apparatus 110 such as a smart phone. As an example, the device 100 can have a display screen 101 and an input section 102 such as a button on the top surface of its housing, but it may be without input/output area such as an IC card. The communication with the apparatus 110 can be wireless or wired, and various methods can be used in establishing a secure communication path between the device 100 and the apparatus 110, and also in allowing the apparatus 110 to access the secret information stored in the device 100.

The apparatus 110 may be, for example, a portable terminal such as a smartphone, or a PC or notebook PC. The apparatus 110 comprises a communication unit 101 such as a communication interface, a processing unit 102 such as a processor, a CPU, etc., and a storage unit 103 including a storage apparatus or a storage medium such as a memory, a hard disk, etc., and can be configured by executing a program for performing each process. The program may include one or more programs, and may be stored on a computer-readable storage medium to form a non-transitory program product. The server 120 may have a similar configuration and may include one or more apparatuses or servers, but not shown in the figure for simplicity.

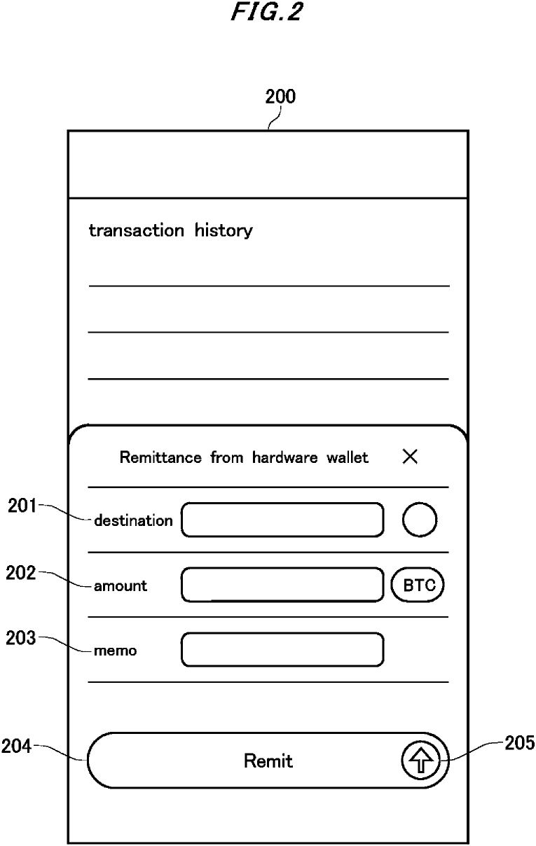

An application for remitting a cryptocurrency can be installed on the apparatus 110. FIG. 2 shows an example of an input screen in an application installed on the apparatus 110. The input screen 200 has an input field 201 for the destination address and an input field 202 for the amount, and a memo field 203 can also be provided. The destination address can be entered by taking a picture of a QR code (registered trademark), and the remittance amount can be entered by selecting the type of virtual currency or cryptocurrency. When the user selects the “Remit” button 204 by tapping or otherwise, the apparatus 110 is given remittance instructions. The user may make an input for enabling or disabling an evacuation function. When the user has turned ON the evacuation function, the evacuation function icon 205 may be displayed near the “Remit” button as an example, as shown in FIG. 2. In the case of OFF, the icon 205 may be hidden or grayed out to visually indicate that the evacuation function is disabled rather than enabled.

In the present embodiment, at the apparatus 110, in response to the user’s instructions to remit a cryptocurrency, in addition to generating a transfer transaction T to remit the instructed remittance amount, the apparatus 110 also generates an evacuation transaction E to remit all or part of the remainder after subtracting the instructed remittance amount from the amount that can be remitted using the secret information managed by the device 100. The signed remittance transaction T′ is broadcasted, but the signed evacuation transaction E′ is not broadcasted, but is stored at the server 120, and the server 120 will broadcast the signed evacuation transaction E′ when it receives separate legitimate evacuation instructions. This is described in more detail below.

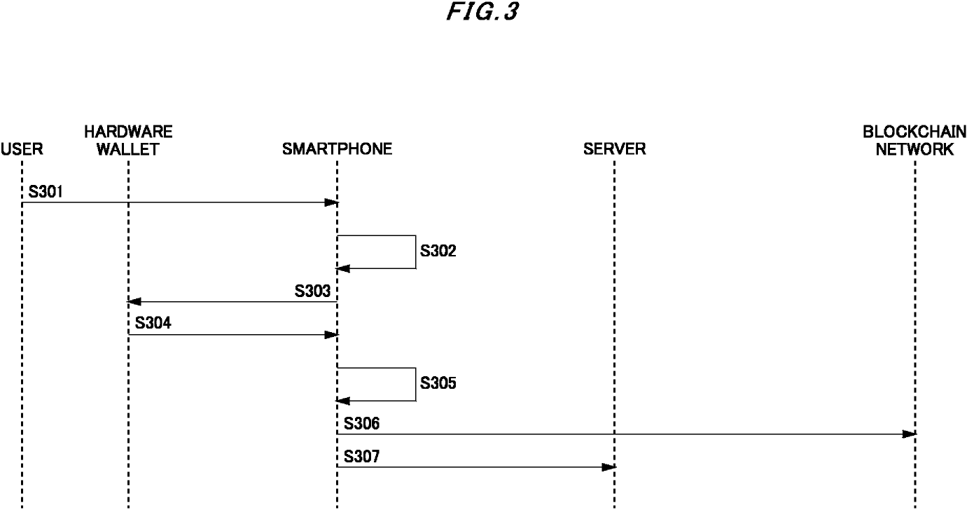

First, the apparatus 110 receives an input of remittance instructions from the user, including a destination address and a remittance amount (S301). In response to the remittance instructions, the apparatus 110 generates remittance transaction data T for remitting the instructed remittance amount. Additionally, the apparatus 110 generates evacuation transaction data E to remit all or part of the remaining amount after subtracting the indicated remittance amount from the amount that can be remitted using secret information managed by the device 100 (S302). Here, the remittance transaction data T and the evacuation transaction data E may be generated simultaneously or one of them may be generated first. In FIG. 3, it is explained that the remittance transaction data T is obtained by generating it in the apparatus 110, but the remittance transaction data T can also be obtained by transmitting a generation request to the server 120 and receiving the generated remittance transaction data T, and the same is true for transaction data E.

The following is a further explanation of the generation of transaction data in the case where the secret information managed by the device 100 is a seed S. The seed S is information from which multiple private keys can be generated in a hierarchical manner, and the public key corresponding to each private key can be generated based on the public key corresponding to the first level private key, which is the parent private key, as the parent public key S′. In the transmission and reception of a cryptocurrency, the address associated with each public key is used, and if the parent public key S′ is known, the multiple addresses associated with the seed S can be deterministically identified. As an example, we may adopt a standard called BIP32. Here, the address associated with a public key may be the public key itself. The parent public key S′ shall be stored in the apparatus 110 in the initial setup between the device 100 and the apparatus 110. When encrypting the seed S managed by the device 100, the encryption key P used to encrypt the seed S shall also be stored in the apparatus 110. The parent public key S′ stored in the apparatus 110 may be stored in the apparatus 110 each time the device 100 becomes able to communicate with the apparatus 110, and the same applies to the encryption key P. Instead of the parent public key S′, each public key generated based on it may be stored in the device 100.

Using the parent public key S′, the apparatus 110 identifies one or more UTXOs that can be used for the remittance of the remittance amount among the plurality of transaction data whose outputs are the plurality of addresses associated with the seed S, and generates transaction data T that uses them as the source of the remittance. In addition, it identifies one or more UTXOs that are not used for the transaction data T among the plurality of transaction data whose outputs are the plurality of addresses associated with the seed S, and generates the evacuation transaction data E that uses all or part of them as the source of the remittance. The remittance destination address of the evacuation transaction data E can be registered as the evacuation destination address. This point will be discussed later.

When the secret information managed by the device 100 is one or more secret keys, the apparatus 110 generates transaction data T with all or part of one or more addresses, associated with one or more public keys corresponding to the one or more secret keys, as the sources of the remittance. In addition, the apparatus 110 generates evacuation transaction data E to remit all or part of the remaining amount after subtracting the amount to be remitted by the transaction data T from the amount that can be remitted using the one or more private keys managed by the device 100. Here, the address associated with each public key may be the public key itself. Each public key may be stored in the apparatus 110 as an initial setting, or it may be stored in the apparatus 110 each time the device 100 becomes capable of communicating with the apparatus 110, and the same is true for the encryption key P.

Next, the apparatus 110 transmits the acquired remittance transaction data T and evacuation transaction data E or their hash values to the device 100 (S303). The device 100 signs the hash values of the remittance transaction data T and the evacuation transaction data E using the secret information stored therein, and transmits the signatures to the apparatus 110 (S304).

Next, the apparatus 110 generates the signed remittance transaction data T′ to which the signature to the hash value of the remittance transaction data T is added, and also generates the signed evacuation transaction data E′ to which the signature to the hash value of the evacuation transaction data E is added (S305).

The apparatus 110 then transmits the signed remittance transaction data T′ to the blockchain network 120 (S306). This may be referred to as “broadcasting”. In doing so, the apparatus 110 may send the signed remittance transaction data T′ directly to any node of the blockchain network 130, or it may call the first API for broadcasting provided by the server 120, with the signed remittance transaction data T′ being an argument, to transmit the signed remittance transaction data T′ through the server 120.

Finally, the apparatus 110 transmits the signed evacuation transaction data E′ toward the server 120 (S307). At this time, the apparatus 110 can also transmit the signed evacuation transaction data E′ to the server 120 by calling the second API for evacuation provided by the server 120, with the signed evacuation transaction data E′ being an argument. The server 120 will store the signed evacuation transaction data E′ without broadcasting it until it receives separate evacuation execution instructions.

When the server 120 receives new signed evacuation transaction data E′ from the same user, it is preferable to discard the old signed evacuation transaction data E′ already stored, if any, and update it with the new one. When the apparatus 110 calls the second API discussed above to transmit the signed evacuation transaction data E′ to the server 120, the server 120 can determine the identity of the user based on the caller’s account.

As explained above, in the method for evacuating a cryptocurrency according to the present embodiment, in response to the user’s instructions to make remittance, remittance transaction data T for the remittance is obtained, and at the same time or in association with it, the evacuation transaction data E for evacuating all or part of the remaining cryptocurrency is obtained. Then, the signed evacuation transaction data E′ is stored on the server 120 without broadcasting it until separate execution instructions for evacuation is received. With the execution instructions for evacuation, the signed evacuation transaction data E′ is broadcasted, and the user can transfer the cryptocurrency from the destination address of the signed evacuation transaction data E′. Therefore, the business operator providing this evacuation service can evacuate the cryptocurrency as needed, such as in an emergency, without accessing each user’s secret information, thus greatly reducing the burden of managing secret information while allowing each user to store a cryptocurrency outside the exchange by themselves.

In addition, in the present embodiment, since the signed evacuation transaction data E′ is stored on the server 120, as a preparation for evacuation, in response to the user’s remittance instructions, the user does not need to pay special attention to the evacuation of the remaining amount of the cryptocurrency, which is highly convenient.

The server 120 can be a server outside the virtual currency exchange, i.e., a server other than the one used to provide the virtual currency exchange, to ensure that the cryptocurrency is stored outside the exchange by each user.

In the above explanation, signatures are made on the device 100. However, if the apparatus 110 itself is capable of securely managing the secret information necessary for remittance, it is conceivable to have the apparatus 110 manage the secret information and provide signatures in the apparatus 110. In other words, the acquisition of a signature to the hash value of the transaction data T or the evacuation transaction data E may be performed by receiving the data from the device 100 or by performing the signature on the apparatus 110. The secret information or corresponding information may be stored in a storage apparatus or storage medium accessible from the device 100 or the apparatus 110 via a computer network, and accessed when necessary for the signature, if it can be managed securely. The storage medium that can be read by the device 100 or the apparatus 110 includes USB memory, SD card, etc. as well as paper media. In the case of paper media, the secret information or corresponding information may be represented and recorded as a two-dimensional code, which may be photographed and read by the image sensor of the device 100 or the apparatus 110.

It is to be noted that if the term “only” is not written, such as in “based only on x”, “in response to x only”, or “in case of x only”, in the present specification, it is assumed that additional information may also be taken into account. Also, as an example, it is to be noted that a description “b is performed in case of a” does not necessarily mean “b is always performed in case of a” or “a is performed immediately after a” except where expressly stated.

In addition, as a caveat, even if there are characteristics of a method, a program, a terminal, an apparatus, a server or a system (hereinafter referred to as “method, etc.”) that perform operations different from those described herein, each aspect of the invention is intended to perform the same operation as one of the operations described herein, and the existence of an operation different from those described herein does not mean that the method, etc. is outside the scope of each aspect of the invention.

### Details of Specifying the Evacuation Address

The evacuation destination address included in the evacuation transaction data E should preferably have the identity of the address holder verified. Specifically, the evacuation address may be an address of the address holder who is verified to be the same person as the registered user of the evacuation service provided by the server 120.

As an example, the address given by the virtual currency exchange to the same person as the registered user may be considered to be acceptable as the evacuation address. For this reason, it is preferable that the evacuation address cannot be manually input by the user, but is specified by the apparatus 110 or server 120 by calling the API provided by the virtual currency exchange. In order for the apparatus 110 to call the API, it is necessary for the user to set the application installed on the apparatus 110 to be able to call the API using the account information of the virtual currency exchange. Various methods can be used for API integration itself.

The evacuation destination address can be an address issued by an application installed on the device 100 or the apparatus 110. Here, the address can be generated using a second seed S′ that is different from the first seed S associated with one or more addresses of one or more UTXOs that comprise the input of the evacuation transaction data E. In this way, the cryptocurrency can be transferred to the address associated with the second seed S′, which is different from the first seed S, even if there is a risk of unauthorized access to the first seed S or the private key generated using the first seed S.

As an example, at the same time as, or before or after broadcasting the signed evacuation transaction data E′, the server 120 notifies the apparatus 110, and in response to the notification, the apparatus 110 may cause an application installed on the device 100 or the apparatus 110 to generate a new third seed S″. The transferred cryptocurrency then becomes the balance of the one or more addresses associated with the second seed S′, and the address associated with the third seed S″ becomes the new evacuation address. The generation of the third seed S″ can be done at various other timings. In any case, by switching the seed within the application, it is possible to evacuate the cryptocurrency to one or more addresses associated with a secure seed without increasing the user burden.

### Details of Execution Instructions of Evacuation

If the user wants to broadcast the signed evacuation transaction data E′ stored in the server 120 to the blockchain network 130 to transfer the cryptocurrency to the evacuation destination address, the user gives the server 120 instructions to perform the evacuation.

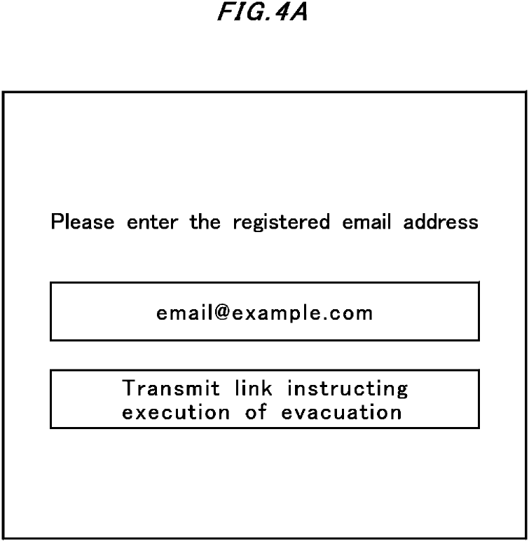

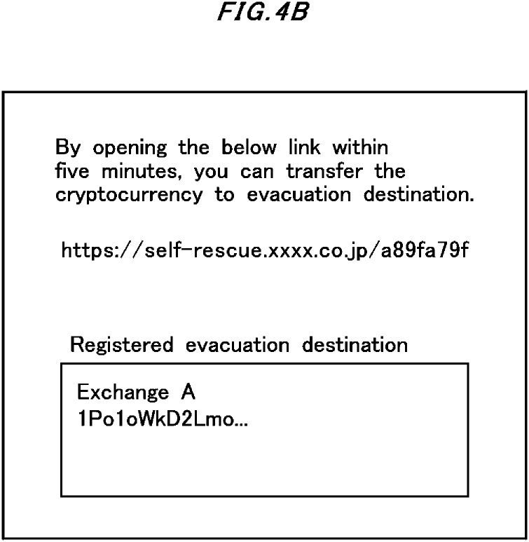

For example, execution instructions of evacuation can be transmitted from an application installed on the apparatus 110, or a request to generate a link for transmitting execution instructions of evacuation can be made on a web page provided by the server 120 (see FIG. 4A), and an evacuation instruction link (see FIG. 4B) can be received. By tapping or clicking on it, the execution instructions of evacuation may be transmitted to the server 120. The ability to transmit execution instructions of evacuation from a web page has the advantage of making evacuation possible even if the apparatus is actually lost, in the case that the apparatus 110 is a portable terminal such as a smartphone that may be lost. In this case, it is preferable that the evacuation destination address is not an address issued or generated by the application installed on the apparatus 110, but an address independent of the application.

### Second Embodiment

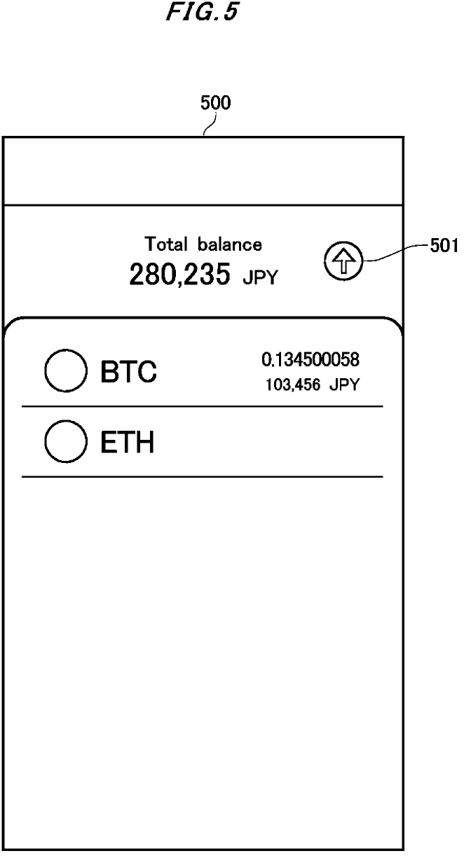

In the first embodiment, the evacuation is prepared in response to the apparatus 110 receiving the input of the user’s instructions to remit a portion of the cryptocurrency. In the second embodiment, the user can update the signed evacuation transaction data E′ stored in the server 120 at any time. For example, as shown in FIG. 5, an update button 501 is displayed on the balance display screen 500 of the cryptocurrency, of which the secret information required for remittance is managed in the device 100 that is shut off from the computer network, so that the user can tap it to give the update instructions, i.e., evacuation preparation instructions, to the apparatus 110. The user may be able to specify the amount to be evacuated, or such specification may be pre-set.

The acquisition of the evacuation transaction E may be performed when a process that causes a change in the amount that can be remitted using the secret information managed, not necessarily user operation, is detected. As the subjects of detection, in addition to processes related to remittance from a remittance source address from which remittance can be made using the secret information, such as remittance instructions by a user or acquisition of a remittance transaction based on such instructions, processes related to deposit into a remittance source address from which remittance can be made using the secret information can be considered.

### Third Embodiment

In the third embodiment, in order for a user to use the evacuation service described in the first and second embodiments, the user is required to have concluded a usage contract with a provider of the evacuation service using the server 120. The user registers on the website provided by the server 120 or through an application installed to the apparatus 110, and pays the required usage fee. By making the usage fee a monthly fee, the user is freed from the labor of managing secret information as data, which reduces the management burden, and the management burden with respect to costs is also reduced. Furthermore, if the cost of the device 100 used by the user is included in the monthly fee, the cost burden on the user is further reduced, and the storage of cryptocurrency without relying on exchanges is greatly promoted.

### Fourth Embodiment

The first through third embodiments assume that the secret information required for remittance is managed outside the virtual currency exchange, but the evacuation using evacuation transaction data E described in the first through third embodiments may be applied to the case where the secret information required for remittance is managed on a server for the virtual currency exchange. In this case, the apparatus 110 in FIG. 1 becomes the server for the virtual currency exchange, and all the aspects described in the first through third embodiments can be adopted in this embodiment as well, to the extent that there is no conflict with the change.

### Reference Signs List

100 device
101 display unit
102 input unit
110 apparatus
120 server
130 blockchain network
200 input screen
201 remittance address input field
202 remittance amount input field
203 memo input field
204 remittance button
205 evacuation function icon
500 balance display screen
501 evacuation function icon

1. A method for evacuating a cryptocurrency of which secret information required for remittance is managed outside a virtual currency exchange by an apparatus, comprising:
receiving an input of remittance instructions of part of the cryptocurrency from a user;
obtaining remittance transaction data for remitting instructed remittance amount;
obtaining evacuation transaction data for evacuating all or part of remainder after subtracting remittance amount of the remittance transaction data from entire amount of the cryptocurrency;
obtaining a signature to a hash value of the remittance transaction data using the secret information;
obtaining a signature to a hash value of the evacuation transaction data using the secret information;
transmitting signed remittance transaction data to a blockchain network; and
transmitting signed evacuation transaction data to a server storing the signed evacuation transaction data.

2. The method according to claim 1, further including transmitting execution instructions of evacuation, which causes the signed evacuation transaction data to be transmitted to the blockchain network, to the server.

3. The method according to claim 1 or 2, wherein the server is a server other than a server for providing a virtual currency exchange.

4. The method according to any one of claims 1 to 3, wherein, in the evacuation transaction data, a destination address which is an evacuation address is an address of which identity of the user has been verified.

5. The method according to claim 1, in the evacuation transaction data, a destination address which is an evacuation address is an address generated by an application installed on the apparatus, which is generated using a second seed different from a first seed associated with one or more addresses of one or more UTXOs that comprise an input of the evacuation transaction data.

6. The method according to claim 1, further comprising receiving an input for validating an evacuation function from the user.

7. The method according to any one of claims 1 to 6, wherein the mobile terminal receives a signature to a hash value of the signed evacuation transaction data from a device shut off from the Internet that stores the secret information.

8. A method for evacuating a cryptocurrency of which secret information required for remittance is managed outside a virtual currency exchange by an apparatus, comprising:
obtaining evacuation transaction data for evacuating all or part of the cryptocurrency;
obtaining a signature to a hash value of the evacuation transaction data using the secret information; and
transmitting signed evacuation transaction data to a server storing the signed evacuation transaction data.

9. A program for causing an apparatus to perform a method for evacuating a cryptocurrency of which secret information required for remittance is managed outside a virtual currency exchange, the method comprising:
obtaining evacuation transaction data for evacuating all or part of the cryptocurrency;
obtaining a signature to a hash value of the evacuation transaction data using the secret information; and
transmitting signed evacuation transaction data to a server storing the signed evacuation transaction data.

10. An apparatus for evacuating a cryptocurrency of which secret information required for remittance is managed outside a virtual currency exchange, configured to:
obtain evacuation transaction data for evacuating all or part of the cryptocurrency;
obtain a signature to a hash value of the evacuation transaction data using the secret information; and
transmit signed evacuation transaction data to a server storing the signed evacuation transaction data.
